(19) United States
(12) Patent Application Publication
(10) Pub. No.: US 2011/0038247 A1
(43) Pub. Date: Feb. 17, 2011

(54) Hard disk damping device

(75) Inventors: Chun-Wang LIN, Rueifang Township (TW); Hung-Tsai PAN, Taipei (TW)

Correspondence Address: RABIN & Berdo, PC, 1101 14TH STREET, NW, SUITE 500, WASHINGTON, DC, 20005, US

(73) Assignee: Quanta Computer Inc., Taoyuan Shien (TW)

(21) Appl. No.: 12/588,153

(22) Filed: Oct. 6, 2009

(30) Foreign Application Priority Data
Aug. 11, 2009 (TW) 098214794

(51) Int. Cl. G11B 17/00

(52) U.S. Cl. 369/247.1; G9B/17

(57) ABSTRACT

A hard disk damping device is disclosed, which includes a hard disk having at least one long side and at least one short side, a side bracket disposed on the long side and having at least one salient, and at least one damping structure disposed on the side bracket. The damping structure has plural protrusions disposed on a surface of the damping structure. The damping structure has at least one slot to couple to the salient.

### RELATED APPLICATIONS

This application claims priority to Taiwan Application Serial Number 98214794, filed Aug. 11, 2009, which is herein incorporated by reference.

### BACKGROUND

1. Technical Field

The present invention relates to a damping device. More particularly, the present invention relates to a hard disk damping device.

2. Description of Related Art

Due to an enormous increase of computer processing speed, computers can handle a significant amount of data and information. Data and information are usually stored on hard disks. Normally, in a computer system, the hard disk is the main storage medium to store programs, files, and various data and information. Therefore, the shockproof structure to prevent the hard disks from shock damage is really important in the computer system.

However, space is limited in laptop computers, so that the components are arranged close together in laptop computers. For example, it is difficult to provide enough distance between the speaker and the hard disk in laptop computers, such that the shock generated by the speaker when the speaker is operated would seriously influence the operation of the hard disk, or the vibrations from the speaker causes the hard disk to resonate. Furthermore, the shockproof space for hard disk is also limited in laptop computers, and thereby reducing the damping efficiency of the hard disk. Therefore, there is a need to increase damping efficiency of the hard disk in laptop computers.

### SUMMARY

An embodiment of the invention provides a hard disk damping device, which includes a hard disk having at least one long side and at least one short side, a side bracket disposed on the long side, at least one damping structure disposed on the side bracket, and a base casing. The damping structure has plural protrusions disposed on a surface of the damping structure. The base casing has at least one holder. The hard disk is disposed in the base casing, and the damping structure is disposed in the holder. The protrusions are contact with the holder.

Another embodiment of the invention provides a hard disk damping device, which includes a hard disk having at least one long side and at least one short side, a side bracket disposed on the long side and having at least one salient, and at least one damping structure disposed on the side bracket. The damping structure has plural protrusions disposed on a surface of the damping structure. The damping structure has at least one slot to couple to the salient.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an explosion diagram of an embodiment of the hard disk damping device of the invention;

FIG. 2 is an oblique diagram of the embodiment of the hard disk damping device of FIG. 1; and

FIG. 3A and FIG. 3B are front view schematic diagram and back view schematic diagram of another embodiment of the hard disk damping device of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

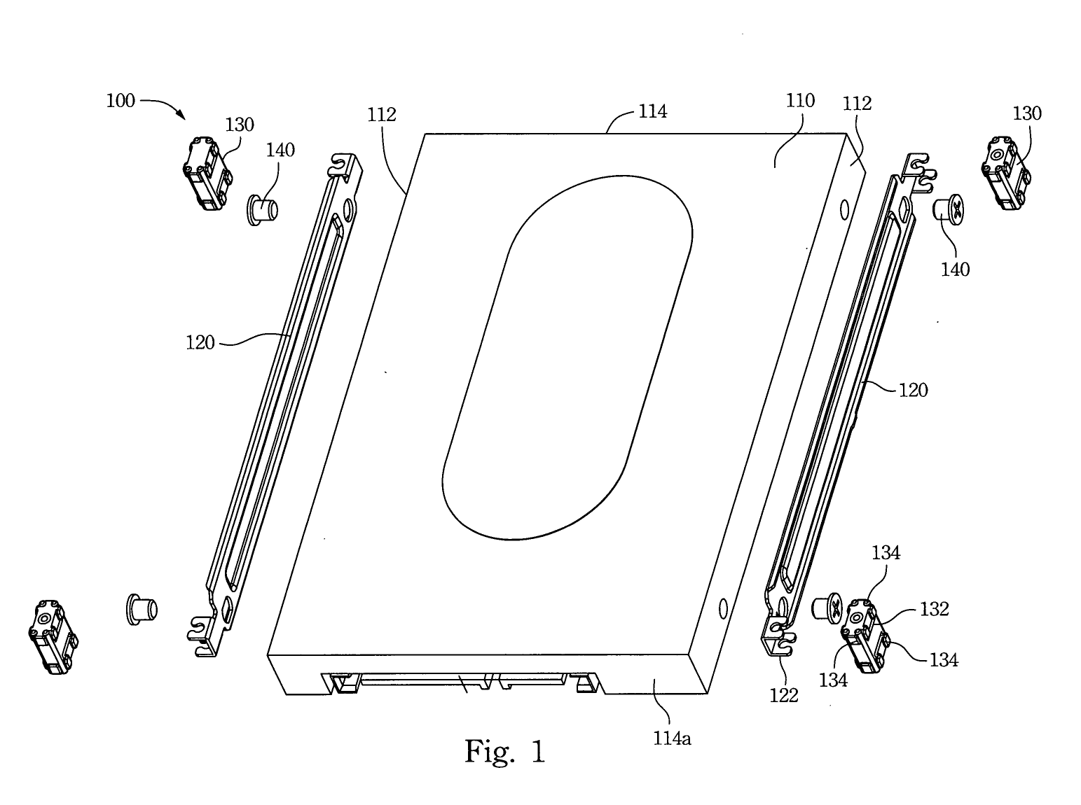

FIG. 1 is an explosion diagram of an embodiment of the hard disk damping device of the invention. The hard disk damping device 100 includes a hard disk 110, at least one side bracket 120, plural damping structures 130, and plural screws 140. The side brackets 120 are fixed on the hard disk 110 with the screws 140, and the damping structures 130 are disposed on the side brackets 120.

The hard disk 110 has two long sides 112 and two short sides 114. The short side 114a has a connecting interface thereon, so that two different types of side brackets 120 are designed to fit the short sides 114, 114a, thereby increasing the cost of opening the mold. Accordingly, the side brackets 120 are disposed on the long sides 112 in the present embodiment, so that the mold opening cost and the production cost of the side bracket 120 can be reduced by the long sides 112 sharing the same side bracket 120.

The side bracket 120 has at least one salient 122. The damping structure 130 has at least one slot 132. The slot 132 of the damping structure 130 is coupled to the salient 122 of the side bracket 120 to fix the damping structure 130 on the side bracket 120. In this embodiment, each side bracket 120 is corresponds to two of the damping structures 130. The damping structures 130 are disposed on two opposite ends of each side bracket 120.

The material of the damping structure 130 is elastic material, such as rubber with damping efficiency. The shape of the damping structure 130 is approximate to a cuboid with six surfaces. The damping structure 130 has plural protrusions 134 disposed on the six surfaces. The protrusions 134 are arranged along three axles of the damping structure 130. The protrusions 134 are symmetrical in the three axles.

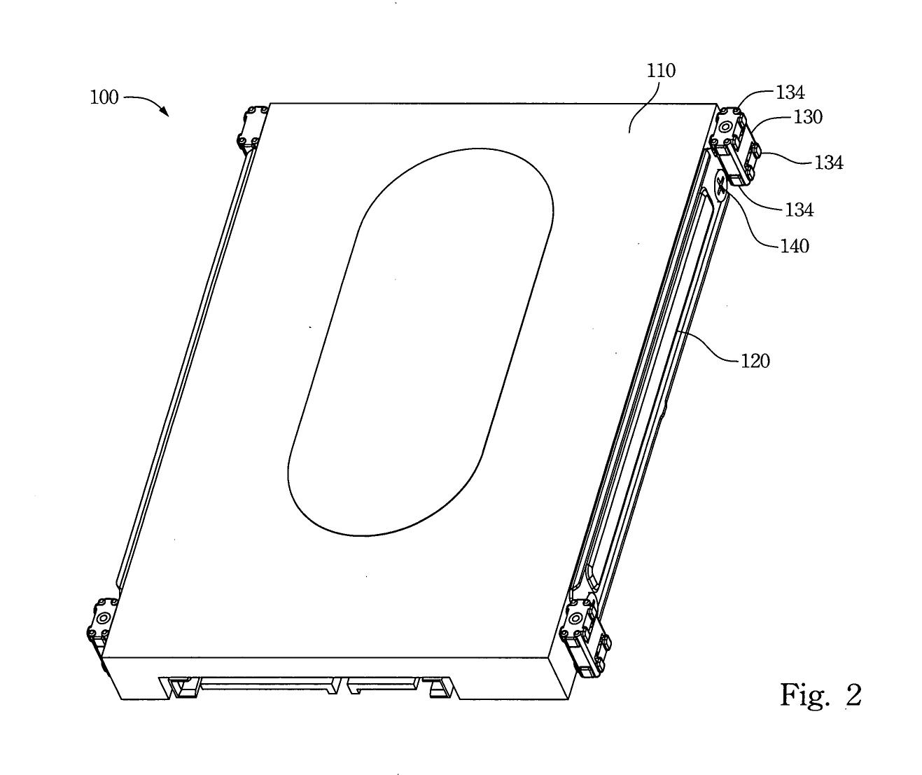

FIG. 2 is an oblique diagram of the embodiment of the hard disk damping device of FIG. 1. The side brackets 120 are fixed on the hard disk 110 with screws 140. The damping structures 130 are coupled to the side brackets 120. The protrusions 134 of the damping structure 130 are arranged along three axles.

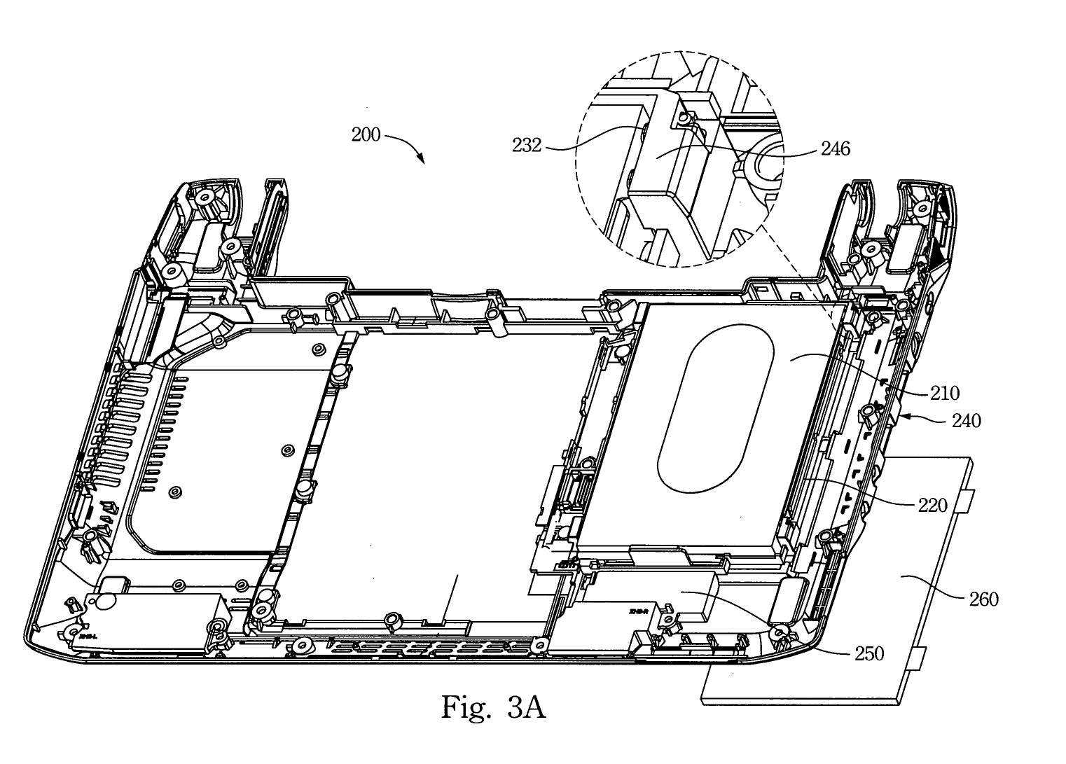

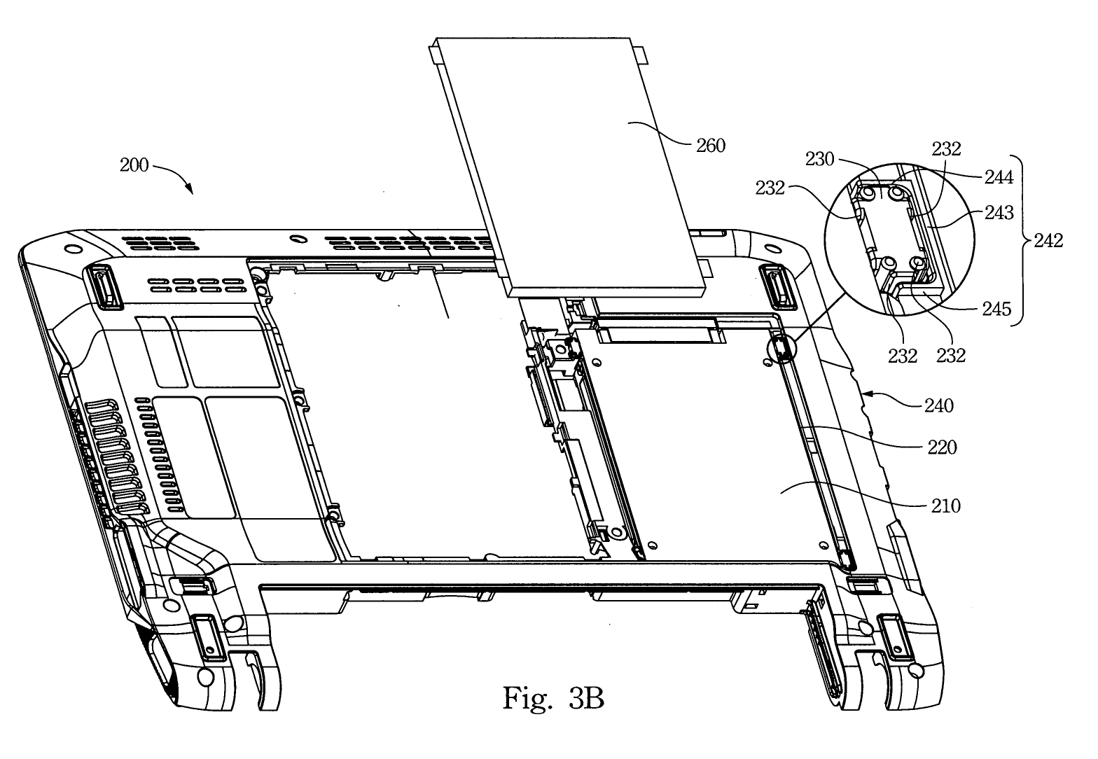

FIG. 3A and FIG. 3B are front view schematic diagram and back view schematic diagram of another embodiment of the hard disk damping device of the invention. The hard disk damping device 200 includes the hard disk 210, the side bracket 220 disposed on the side of the hard disk 210, the damping structures 230 disposed on the side bracket 220, and a base casing 240. The hard disk 210 is disposed in the base casing 240. The base casing 240 has plural holders 242 for containing the damping structures 230. The protrusions 232 of the damping structure 230 touch the holder 242, thus the movement of the damping structures 230 is limited by the holders 242 of the base casing 240.

The base casing 240 in this embodiment is a laptop computer casing. The side brackets 220 are disposed on the long sides of the hard disk 210. The damping structures 230 are disposed on the opposite ends of the side bracket 220. The shape of the holder 242 is approximate to a rectangle.

The holder 242 has a first side surface 243, a second side surface 244, and a third side surface 245 corresponding to second side surface 244. The protrusions 232 are contact with the first side surface 243, the second side surface 244, and the third side surface 245. The holder 242 has a bottom surface 246. The hard disk damping device 200 further includes a cover 260. The hard disk 210 is disposed between the cover 260 and the base casing 240. The protrusions 232 of the damping structure 230 are contact with the cover 260 and the bottom surface 246.

In this embodiment, the damping structures 230 are arranged at the corners of the hard disk 210. There is a speaker 250 arranged next to the hard disk 210. The protrusions 232 of the damping structure 20 are contact with the holder 242 of the base casing 240. The protrusions 232 are made of elastic material, so that the protrusions 232 can provide a damping stroke between the hard disk 210 and the base casing 240 to enhance damping efficiency and to prevent resonance between the hard disk 210 and the speaker 250.

Although the present invention has been described in considerable detail with reference to certain embodiments thereof, other embodiments are possible. Therefore, the spirit and scope of the appended claims should no be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hard disk damping device comprising:
a hard disk comprising at least one long side and at least one short side;
a side bracket disposed on the long side;
at least one damping structure disposed on the side bracket, wherein the damping structure comprises a plurality of protrusions disposed on a surface of the damping structure; and
a base casing comprising at least one holder, wherein the hard disk is disposed in the base casing, and the damping structure is disposed in the holder, wherein the protrusions are contact with the holder.

2. The hard disk damping device of claim 1, wherein the side bracket comprises at least one salient, and the damping structure comprises at least one slot to couple to the salient.

3. The hard disk damping device of claim 1, wherein there are two of the damping structures disposed on the side bracket, and the damping structures are disposed on opposite ends of the side bracket,

4. The hard disk damping device of claim 3, wherein the side bracket comprises a plurality of salients, and each damping structure comprises at least one slot to couple to the salients.

5. The hard disk damping device of claim 1, wherein the shape of the holder is a rectangle, the holder comprises a first side surface, a second side surface, and a third side surface corresponding to the second side surface.

6. The hard disk damping device of claim 5, wherein the protrusions are contact with the first side surface, the second side surface, and the third side surface.

7. The hard disk damping device of claim 1, further comprising a cover, to wherein the hard disk is disposed between the cover and the base casing.

8. The hard disk damping device of claim 7, wherein the holder comprises a bottom surface, and the protrusions are contact with the cover and the bottom surface.

9. The hard damping device of claim 1, wherein the base casing is a laptop computer casing.

10. The hard disk damping device of claim 1, wherein the material of the damping structure is an elastic material.

11. The hard disk damping device of claim 10, wherein the elastic material comprises rubber.

12. The hard disk damping device of claim 1, further comprising a plurality of screws to fix the side bracket on the hard disk.

13. A hard disk damping device comprising:
a hard disk comprising at least one long side and at least one short side;
a side bracket disposed on the long side and comprising at least one salient; and
at least one damping structure disposed on the side bracket, wherein the damping structure comprises a plurality of protrusions disposed on a surface of the damping structure, and at least one slot to couple to the salient.

14. The hard disk damping device of claim 13, wherein there are two of the damping structures disposed on the side bracket, and the damping structures are disposed on opposite ends of the side bracket,

15. The hard disk damping device of claim 13, wherein the material of the damping structure is an elastic material.

16. The hard disk damping device of claim 15, wherein the elastic material comprises rubber.

17. The hard disk damping device of claim 13, further comprising a plurality of screws to fix the side bracket on the hard disk.

18. The hard disk damping device of claim 13, wherein each damping structure is a cuboid with six surfaces, and the protrusions are disposed on the six surfaces.
